(19) United States
(12) Patent Application Publication
(10) Pub. No.: US 2005/0286412 A1
(43) Pub. Date: Dec. 29, 2005

(54) Transient notification system

(75) Inventors: Fang Hao, Morganville, NJ (US); Pramod V.N. Koppol, Aberdeen, NJ (US)

Correspondence Address: SYNNESTVEDT & LECHNER, LLP, 2600 ARAMARK TOWER, 1101 MARKET STREET, PHILADELPHIA, PA, 191072950, US

(73) Assignee: Lucent Technologies Inc., Murray Hill, NJ (US)

(21) Appl. No.: 10/875,124

(22) Filed: Jun. 23, 2004

(51) Int. Cl. H04L 12/26; H04L 12/28

(52) U.S. Cl. 370/216; 370/254; 370/401

(57) ABSTRACT

A transient notification system is described. In one implementation, a Border Gateway Protocol (BGP) speaker receives a transience notification message identifying a route in a network that is no longer valid. The BGP speaker marks the route indicated by the transient notification message as not valid, and avoids using the route for transferring data to a destination. The transient notification message is forwarded faster than standard route advertisement messages.

### TECHNICAL FIELD

The present invention relates generally to packet-based networks, and more specifically, to improving Internet routing convergence times in such networks.

### BACKGROUND

A router is a device that connects one independent network to one or more other independent networks. A router is responsible for finding the best path for forwarding data packets among networks. That is, a router stores and forwards electronic messages between networks, first determining potential paths to a destination, and then selecting a most expedient route to the destination.

Routers use routing protocols to exchange information regarding the appropriate path over which data is transmitted to its eventual destination. The routing protocols also specify how routers in a network share information with each other and report changes. The routing protocols enable routers to make dynamic adjustments in the event of changes to routing conditions, such as traffic congestion, network failures, new path destinations, etc. In most instances, routing protocols enable routers to continually advertise routes (i.e., paths) to a destination. Typically, each router maintains available routes to a destination in a routing table, based on information gleaned from the routing protocols.

One common routing protocol used by routers is called the Border Gateway Protocol (BGP). BGP is an exterior gateway routing protocol that enables groups of routers to share routing information so that efficient, loop-free routes can be established for transferring data between Autonomous Systems (ASs). Typically, an AS (also referred to as a domain) is a network under one governing authority, such as an ISP.

In accordance with the BGP, neighboring routers initially exchange routing information contained in their routing tables. Thereafter, they tend to only send incremental updates to handle changes to routing conditions such as those mentioned above, i.e., traffic congestion, network failures, new path destinations, etc. When a router receives an update from peer routers that describe different paths to the same destination, the router must choose the single best path for reaching that destination based on policies defined by its own AS.

One drawback associated with routing updates and the BGP routing protocol, is that it often takes a substantial amount of time and voluminous amounts of messages sent between routers, before the routers “converge” (i.e., the time it takes a network to stabilize after some event) following notification of an update in the Internet. In other words, there is a period of time following a network routing change (due to a failure or some other event) before the routing change is (i) fully communicated to all the routers; (ii) the routers' routing tables are adjusted so that all the routers use the correct paths for reaching their destinations, and (iii) a stable set or paths for reaching destinations are reestablished.

Network routing remains unstable, however, until there is such convergence. Instability during the convergence process can cause packets to be lost due to a lack of connectivity as well as traffic to be forwarded to a potential wrong path or to a destination that is out-of-service. Additionally, the instability may be exacerbated by having to take on additional traffic overhead demands associated with messages sent to update routing paths. Moreover, this network instability can spread across AS peers and propagate throughout the Internet. Thus, a reduction in convergence latency times will minimize the period of time networks remain unstable.

While researchers in this area have started to analyze the BGP convergence problem, there is currently no satisfactory solution to substantially reduce convergence latency times.

### SUMMARY

A transient notification system is described. In one implementation, a Border Gateway Protocol (BGP) speaker receives a transience notification message identifying a route in a network that is no longer valid. The BGP speaker marks the route indicated by the transient notification message as not valid, and avoids using the route for transferring data to a destination. The transient notification message is forwarded faster than standard route advertisement messages.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates an exemplary network environment in which transient notification messages are exchanged among BGP speakers.

FIG. 2 illustrates a routing table containing symbolic routing information.

FIG. 3 illustrates an example transient notification message.

FIG. 4 illustrates an exemplary physical representation of a computer platform used to implement various nodes in a network.

FIG. 5 illustrates an exemplary transient notification system for use in a network.

FIG. 6 illustrates an exemplary method for exchanging transient notification messages.

### DETAILED DESCRIPTION

Overview

A transient notification system is described. In one implementation, a message, called a transient notification message, is exchanged among devices conversant in the BGP routing protocol (such as routers) indicating a path between routers that is no longer valid (i.e., it is unavailable) due to some network failure or as a result of a planned change in the network. The transient notification message is sent at a higher-priority than other messages and hence is sent (and is processed) faster than standard routing protocol messages.

Accordingly, the described transient notification system reduces convergence times and messaging overhead exchanged between routers, because the transient notification message indicates precisely which path is no longer valid. That is, the transience notification message provides an immediate indication of which path(s) are no longer valid. Upon receipt of a transient notification message, the router simply marks the route as being transient (i.e., unavailable or invalid), effectively deactivating any fields in the router's information routing table that includes the invalid path in any routes to a destination. The transient notification message does not induce the invocation of a decision algorithm. Rather the decision algorithm is invoked in accordance with standard routing protocols, upon receipt of one or more route update or withdrawal messages usually sent after the transient notification message is already received.

The aforementioned techniques, overcomes many of the conventional problems associated with receiving inadequate information after some event (i.e., a node failure or natural change). For instance, after an event failure, conventional solutions may send a message withdrawing a previous path or advertising new paths after an event failure. No straightforward message, however, is ever sent indicating exactly which path is invalid so that a router can identify and immediately avoid using that route. The innovative features described herein, overcomes these problems by transmitting a succinct message to other routers indicating which particular path is invalid. By knowing exactly which path is invalid and on a priority basis (i.e., faster than standard route advertisement messages are processed and forwarded), routers avoid having to explore a large quantity of alternative paths to a destination while continuing to potentially transmit data through the invalid path. Accordingly, convergence latency times and messaging overhead reduced, and packet losses are also minimized. As used herein the terms, route, path, and pathway are generally used interchangeably and refer to a communication link between two or more nodes.

Most of the techniques described herein are implemented in conjunction with the Border Gate Protocol (BGP) routing protocol. The discussion assumes the reader is familiar with the Internet architecture and the BGP routing protocol. For a basic introduction to Interent and BGP, the reader is directed to the following papers, Y. Rekhter and t. Li, “A Border Gateway Protocol 4 (bgp4),” Internet Draft, Internet Engineering Task Force, (Work in Progress); John W. Stewart III, “BGP4: Inter-domain routing in the Internet”, (1999); and C. Labovitz, et al. “The Impact of Internet Policy and Topology on Delayed Routing Convergence,” INFOCOM, (April 2001), which are all incorporated by reference. It is noted, that while the described implementations, refer primarily to devices conversant in the BGP, often referred to as “BGP speakers,” it is possible that innovative features described herein may be utilized in conjunction with other distance vector or path vector routing protocols.

Network Environment

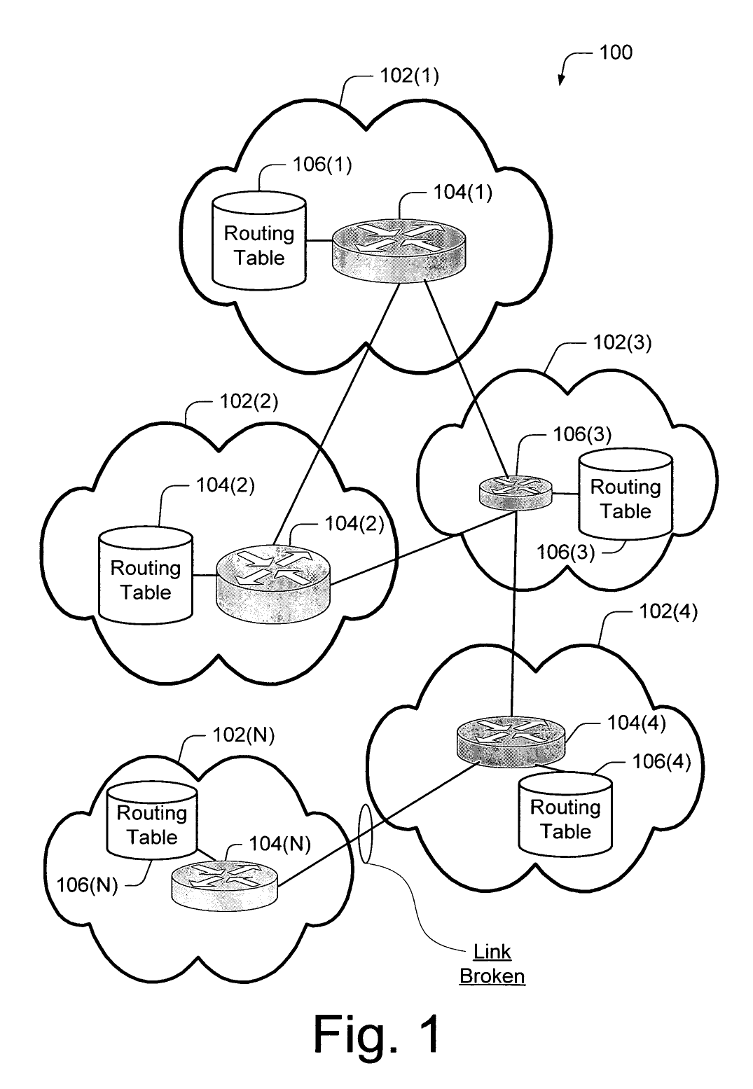

FIG. 1 illustrates an exemplary network environment 100 in which transient notification messages are exchanged among BGP speakers. The transient notification message indicates path(s) that are no longer valid due to some network failure or as a result of a planned change in the network. Network environment 100 is intended to represent any of variety of network topologies and types including wired and/or wireless networks. Network 100 may also include at least a portion the Internet.

Network environment 100 includes Autonomous Systems (ASs) 102(1), 102(2), 102(3), 102(4), . . . , 102(N). Each AS, referred to generally as reference number 102 may include one or more networks (not shown), such as local area networks (LANs) and/or wide area networks (WANs). The term AS may also be referred to as a domain herein. Each AS 102 also includes at least one BGP speaker 104(1), 104(2), 104(3), 104(4), . . . . 104(N).

A BGP speaker refers to any node in a network capable of communicating with other nodes using the BGP routing protocol. Generally, a BGP speaker, referred to generally as reference number 104, serves as an access point for packets to enter/exit an AS 102. Accordingly, each BGP speaker may be implemented as a router, a bridge, a switch, a server, a gateway device, any combination of such devices, and/or as a related computer system. It is noted that only one BGP speaker is shown to reside in each AS 102 for illustration and discussion purposes, although it is appreciated that more than one BGP speaker may be included in each AS 102.

Each BGP speaker 104 creates and dynamically maintains a routing table 106 (or routing information base), which is a database containing routing information that is typically stored locally with the BGP speaker 104. Each BGP speaker 104 uses the routing information to forward packets to their destination by determining the best route thereto.

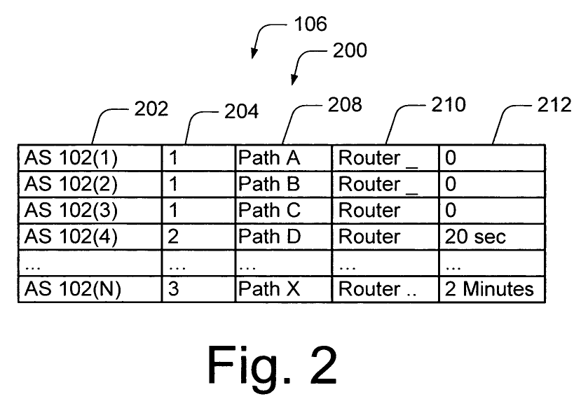

For instance, FIG. 2 illustrates a routing table 106 containing symbolic routing information. In particular, routing table 106 includes various network fields 200, such as a network number field 202, hops to network field 204, route to reach destination field 208, neighboring router(s) field 210, and an aging timer field 212.

Network number field 202 includes a list of networks each BGP speaker 104 is currently aware. When a packet is forwarded to a particular BGP speaker 104, the BGP speaker 104 uses the destination network number from the packet's header and matches it with any network numbers in the network number field 202, to obtain routing instructions for forwarding the packet.

Hops to network field 204 indicates the number of BGP speakers (hops) that must be traversed to reach each destination.

Route to reach destination field 208 indicates the necessary path to reach the destination.

Neighboring router(s) field 210 indicates the next hop or peer BGP speaker.

Aging timer field 212 is a timer used by each BGP speaker to make sure that the neighboring BGP speaker indicated in neighboring router field 210 is current. That is each time each BGP speaker 104 receives information from the neighboring BGP speaker, the aging timer field 212 is reset to zero. On the other hand, if no active communication messages are received from the neighboring BGP speaker after a predetermined period of time, the BGP speaker may assume that its neighboring BGP speaker is unavailable. As shall be explained this may provide one of several techniques used by a BGP speaker to detect whether a link to a neighboring BGP speaker is unavailable. Other techniques may be used to determine whether a BGP speaker or link is unavailable such as by actively pinging neighboring BGP speakers on a periodic basis to ascertain whether the route is still active etc.

It is noted that routing table 106 shown in FIG. 2 represents a logical grouping of information, and that specific implementation may choose to distribute the information in more (or fewer) fields than shown. For example, the routing table 106 may include a throughput field, a reliability field, and other information as is appreciated by those skilled in the art.

Referring back to FIG. 1, for purposes of discussion herein, suppose that BGP speaker 104(1) is the origin of a packet and BGP speaker 104(N) is the destination for the packet. BGP speaker 104(1) has two active routes for reaching destination 104(N): BGP speaker 104(1) can choose active path 104(2)-104(3)-104(4)-104(N) or active path 104(3)-104(4)-104(N). For purposes of discussion, also suppose that the link 104(4)-104(N) between BGP speaker 104(4) and BGP speaker 104(N) goes down. This may have been caused by failure of BGP speaker 104(N) or a failed physical route 104(4)-104(N). In either situation, all the routes that pass through the route 104(4)-104(N) (sometimes referred to as the “transient route”) are invalid and no longer available.

In this scenario, BGP speaker 104(4) should detect that the link between it and BGP 104(N) is unavailable before the other BGP speakers 104(1), 104(2), and 104(3), since BGP speaker 104(N) is a neighbor to BGP speaker 104(4) and BGP speaker 104(4) is able to directly monitor the route 104(4)-104(N). BGP speaker 104(4) will search its routing table 106(4) for any routes containing the route 104(4)-104(N), and will immediately deactivate any fields in the routing table comprising the route 104(4)-104(N). BGP speaker 104(4) will also issue a transient notification message to any neighboring BGP speaker for which it previously advertised route 104(4)-104(N). The transient notification message indicates that the pathway between it and the particular neighboring BGP speaker is unavailable. According to this example, the transient notification message is sent to BGP speaker 104(3).

When BGP speaker 104(3) receives the transient notification message from BGP speaker 104(4), BGP speaker 104(3) searches its routing table 106(3) for any fields containing the active route 104(4)-104(N). BGP speaker 104(3) will mark such fields in the routing table comprising the route 104(4)-104(N) indicated by the transient notification message as invalid. BGP speaker 104(3), will also transmit a transient notification message to any neighbors for which this route may have been previously advertised. Accordingly, BGP speaker 104(3) will propagate a transient notification message to BGP speakers 104(1) and 104(2).

BGP speaker 104(1) and 104(2) should receive the transient notification message around the same time from BGP speaker 104(3). They will likewise search their routing tables 106(1) and 106(2) for any fields containing the active route 104(4)-104(N). BGP speakers 104(1) and 104(2) will mark such fields in the routing table comprising the transient route 104(4)-104(N) indicated by the transient notification message as invalid. BGP speakers 104(1) and 104(2), will also transmit a transient notification message to any neighbors for which this route may have been previously advertised. Accordingly, BGP speaker 104(2) may send a transient notification message to BGP speaker 104(1), even though BGP speaker 104(1) already received the message from BGP speaker 104(3).

At this point, BGP speakers 104(1), 104(2), 104(3) and 104(4), know to avoid transmitting packets to destination 104(N) over any pathway that includes the transient route 104(4)-104(N).

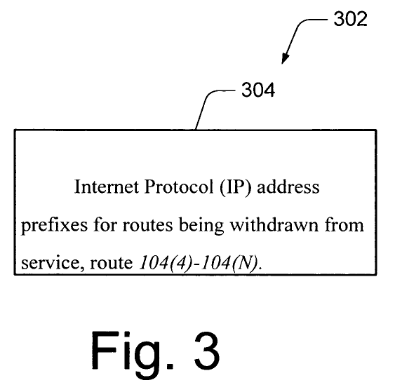

In one implementation, the transient notification message takes the form of a BGP update message, but only contains the withdrawn prefixes list and no route updates. For instance, FIG. 3 illustrates an example transient notification message 302. Message 302 includes a withdraw field 304. Withdraw field 304 contains as list of Internet Protocol (IP) address prefixes for routes being withdrawn from service, such as route 104(4)-104(N) (FIG. 1). Based on this field, each BGP speaker 104 (FIG. 1) is able to withdraw specific entries from their routing tables 106. Although not shown in message 302, it is possible that other fields may be included such as an unforeseen route length field, a total path attribute length field, a path attribute field and other various fields associated with BGP messages. For more information about BGP update messages and their contents, please see the current version of the BGP specification (which is currently BGP version 4), incorporated herein by reference.

Each transience notification message 302 is forwarded faster than standard route advertisement messages by setting an advertisement interval of the transience notification message to be shorter in duration than the advertisement intervals for standard route advertisement messages. In one implementation, this is accomplished by setting the minimum advertisement interval timer to 30 seconds for standard route advertisement messages, and by setting the minimum advertisement interval timer to a duration less than 30 seconds, such as 15 seconds. Of course, the interval timer for either message type may be set at different rates (faster or slower) depending on the implementation. This makes the transient notification message propagate faster than regular BGP messages, but not so fast that the network cannot handle the load. Also, by sending and propagating the transient notification message at a higher priority than other messages, ensures that notification of transient routes are propagated further into the network as soon as they can be identified, so that the transient routes are not used or advertised as a valid route in the network. The process notifying BGP speakers of transient routes is referred to as “suppressing transient routes” and avoids packets being sent to a black hole (invalid route) where packets are dropped.

It is also noted that by sending the withdraw message before update information, allows the network to disable a bad route before attempting to perform the time-consuming rerouting processes. Again, this enables transient routes to be immediately removed from the network before updates are communicated. This reduces convergence times, because BGP speakers are prevented from making routing decisions based upon outdated or inaccurate information.

Having introduced the exemplary network environment, it is now possible to describe an exemplary physical platform that may be used to implement one or more nodes in network 100.

Exemplary Computer Platform

Any functionality provided by BGP speakers can be implemented in any general purpose or special purpose computing system. Examples of well known computing systems, environments, and/or configurations that may be suitable for use with any one of the BGP speakers include, but are not limited to, personal computers, server computers, multiprocessor systems, microprocessor-based systems, network computers, routers, gateways, bridges, optical switches, wireless routers, minicomputers, mainframe computers, distributed computing environments that include any of the above systems or devices, and the like.

Additionally, any exemplary functionality provided by BGP speakers 104 may be described in the general context of computer-executable instructions, such as program modules, being executed by a computer. Generally, program modules include routines, programs, objects, components, data structures, logic, and other executable data that perform particular tasks or implement particular abstract data types. Functionality provided in network environment 100 can also be practiced in a distributed computing environment where tasks are performed by remote nodes that are linked through ASs 102. In a distributed computing environment, program modules may be located in both local and remote computer storage media including memory storage devices.

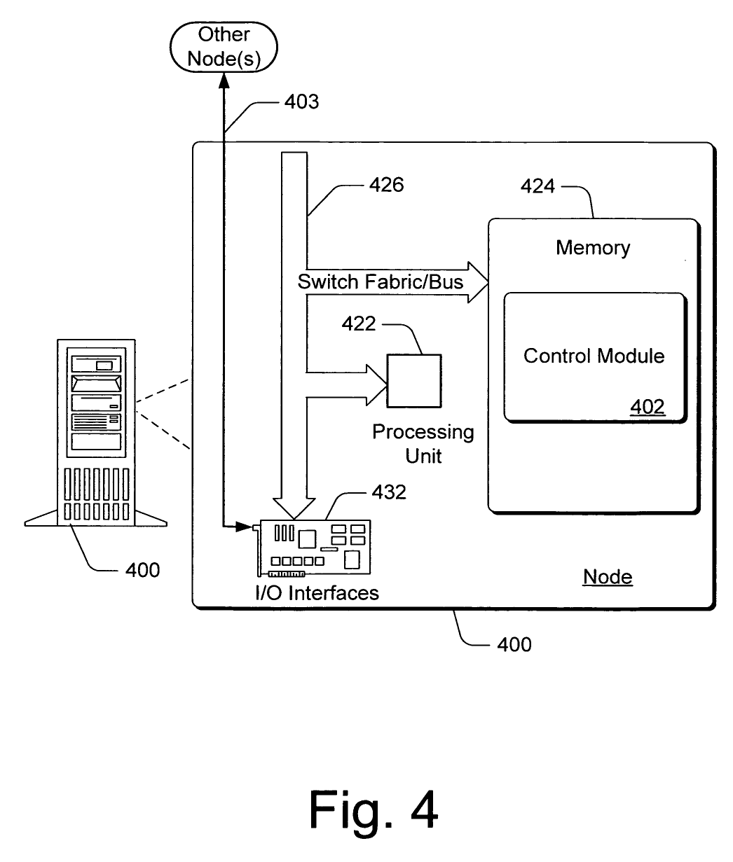

FIG. 4 illustrates an exemplary physical representation of a computer platform 400 used to implement various nodes in network 100. In particular, computer platform 400 represents any general purpose or special purpose computing system used to implement a BGP speaker with minor modifications to hardware, firmware, and/or software. Computer platform 400 is only one example of computer platform and is not intended to suggest any limitation as to the scope of use or functionality of any of the nodes and networks described herein. Neither should the computer platform 400 be interpreted as having any dependency or requirement relating to any one or combination of components described herein.

Each BGP speaker includes a control module 402, which controls the operation of the node. Each control module 402 can be implemented in hardware, firmware, logic, software, or any combination of thereof. In the illustrative exemplary implementation control module 402 is implemented as a program module that may be described in the general context of computer-executable instructions, being executed by a computer, i.e., one or more processors in a processing unit 422. Control module 402 resides in memory 424.

Memory 424 typically includes a variety of computer readable media. Such media can be any available media that is accessible by computer platform 200 and includes both volatile and non-volatile media, removable and non-removable media. The computer-readable media provide non-volatile storage of computer readable instructions, data structures, program modules, and other data for computer platform 400. Any number of program modules can be stored in the computer readable media of memory 424, including one or more portions of control module 402.

It is also noted that portions of control module 402 may be stored in a remote memory storage device remote from computer platform 400. Additionally, even though control module 402 is illustrated herein as a discrete block, it is recognized that any of these components may reside at various times in different storage components of computer platform 400 and are executed by one or more processors of a computer, such as processing units 422.

Computer platform 400 is connected to other nodes via a communication link 403. In particular, communication link 403 connects line cards 432 to network 100.

Having introduced an exemplary network environment and an exemplary computer platform for each BGP speaker, it is now possible to describe an exemplary transient notification system used to suppress transient updates and improve BGP convergence behavior.

Transient Notification System

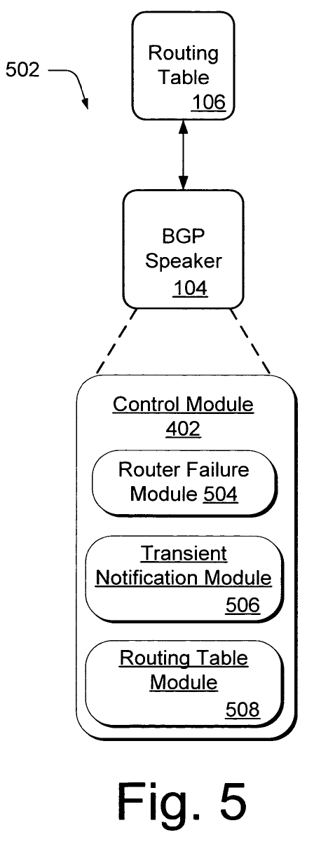

FIG. 5 illustrates an exemplary transient notification system 502 for use in network environment 100. Traceback system 502 is distributed and in incorporated BGP speakers 104. Transient notification system 502 is typically stored in control module 402 (FIG. 4) of the computer platform for which it is associated. For example, in one implementation, transient notification system 502 represents computer-executable instructions executed by a processing unit 422 (FIG. 4) of a computer, but could also be implemented in hardware or any combination of hardware, firmware, logic, and software.

In the illustrious implementation, transient notification system 502 includes: a router failure module 504, a transient notification module 506, and a routing table module 508. Router failure module 504 is configured to detect when a neighboring BGP speaker (or a link) is unavailable. Detecting whether the BGP is speaker or a specific link is down may be accomplished in a number ways as described above. For instance, an aging timer can be used that is reset to zero each time the BGP speaker receives information from the neighboring BGP speaker. However, if the aging timer reaches a predetermined value in which no information is received from the neighboring BGP speaker, the router failure module 504 can assume that the neighboring BGP speaker (or link) is unavailable. Alternatively, active ping messages may be sent on a periodic basis to check whether a particular link is still working.

Router failure module 504 is also configured to receive transient notification messages from other BGP speakers indicating that a particular link is down. The message is then processed at high priority by transient notification module 506 and routing table module 508.

When transient notification module 506 receives a indication from the router failure module 504 that a particular route is invalid, transient notification module 506 is configured to transmit a transient notification message 302 (FIG. 3) to one or more other speakers indicating the particular pathway (and/or BGP speaker) that is unavailable. As discussed above, transient notification module 506 sends the transient notification message at a higher priority than other routing protocol messages.

Routing table module 508 is configured to mark any routes indicated by the router failure module 504 invalid. This is accomplished by searching the routing table 106 for routing information including the route that is no longer valid, and marking the particular routing information as not valid. The process of searching may include looking for any fields in the routing table 106 that mention using the transient route as an active potential route. The process of marking the particular routing information as not valid may be performed in any number of ways, such as deactivating the field containing the invalid route, discarding (erasing) the field containing the route, overwriting the field containing the invalid route, and using possibly other database discarding procedures.

Additionally, transient notification module 506 may rely on routing table module 508 for identifying the transient route to any neighboring routers for which the route indicated by the transient notification message was previously advertised.

Although transient notification system 502 is shown to include three distinct functional blocks (a router failure module 504, a transient notification module 506, and a routing table module 508), it is understood that when actually implemented in the form of computer-executable instructions, logic, firmware, and/or hardware, that the functionality described with reference to each block may not exist as separate identifiable modules. The transient notification system 502 may also be integrated with other components or as a module in a larger system. In most instances, whether integrated or not, transient notification system 502 enables transient routes to be identified and propagated throughout a network as quickly and efficiently as possible, while at the same time reducing traffic overhead, packet losses, and convergence times.

Having introduced various components of a transient notification system 502, it is now possible to describe how transient notification system 502 operates.

Methods of Operation

Methods for exchanging transient nonfiction messages may be described in the general context of processor-executable instructions. The described methods may also be practiced in distributed computing environments where functions are performed by remote processing devices that are linked through a communications network. In a distributed computing environment, computer-executable instructions may be located in both local and remote storage media, including memory storage devices.

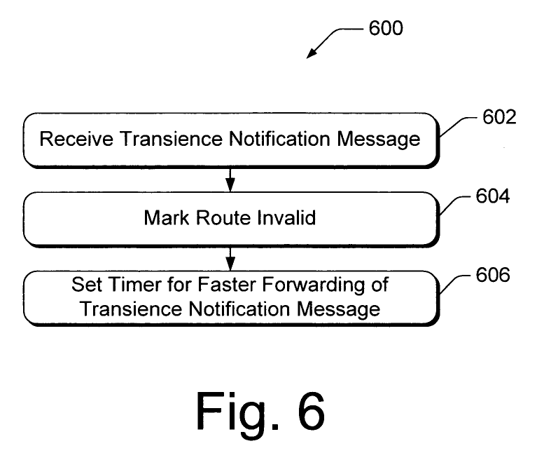

FIG. 6 illustrates an exemplary method 600 for exchanging transient notification messages. Method 600 enables a BGP speaker to receive, process, and transmit transient notification messages to suppress transient updates. Method 600 includes blocks 602, 604, and 606 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof.

Exemplary method 600 shall be described interchangeably with reference to FIGS. 1, 2, 3, 4 and 5. For purposes of discussion, method 600 is illustrated from the perspective of BGP speaker 104(1) in FIG. 1, but can apply to any node in a network 100 (FIG. 1).

In block 602, a transience notification message is received identifying a route in a network that is no longer valid. For example, BGP speaker 104(1) (FIG. 1) receives a transience notification 302 (FIG. 3), indicating either a BGP speaker and/or route that is no longer valid.

In block 604, the route (and/or BGP speaker) identified in the transience notification message is marked invalid. That is, BGP speaker 104(1) (FIG. 1) marks the route invalid by deactivating (discarding, erasing, etc.) any fields in routing table 106(1) containing the route (and/or BGP speaker) indicated by the transient notification message.

In block 606, each transience notification message 302 is forwarded to other BGP speakers faster than standard route advertisement messages by setting an advertisement interval for the transience notification message to be shorter in duration than the advertisement intervals for standard route advertisement messages. This enables the transience notification message to arrive at BGP speaker 104(1) faster than other standard route advertisement messages, but slower than a maximum peak rate.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method, comprising:
receiving a transience notification message identifying a route in a network that is no longer valid;
marking the route invalid; and
forwarding the transience notification message faster than standard route advertisement messages.

2. The method as recited in claim 1, wherein a Border Gateway Protocol (BGP) speaker receives the transience notification message.

3. The method as recited in claim 1, further comprises avoiding transmitting packets to a destination over a pathway that includes the transient route.

4. The method as recited in claim 2, further comprising forwarding the transience notification message to other BGP speakers to which the route was previously advertised.

5. The method as recited in claim 2, wherein forwarding the transience notification message faster than standard route advertisement messages comprises setting an advertisement interval of the transience notification message to be a shorter in duration than advertisement intervals for standard route advertisement messages.

6. The method as recited in claim 2, wherein forwarding the transience notification message faster than standard route advertisement messages does not require instantaneous processing and forwarding of the transience notification message.

7. The method as recited in claim 1, wherein marking the route invalid comprises deactivating any fields in a routing table containing the route indicated by the transient notification message.

8. One or more computer-readable media having stored thereon computer executable instructions that, when executed by one or more processors, causes the one or more processors of a computer system to:
receive a transience notification message identifying a route that is no longer valid;
prioritize the transience notification message over standard routing protocol messages; and
invalidate the route indicated by the transience notification message.

9. One or more computer-readable media as recited in claim 8, wherein the transient notification message comprises a prefix identifying the route that is no longer valid.

10. One or more computer-readable media as recited in claim 8, wherein the transient notification message comprises a prefix identifying the route that is no longer valid, and an update associated with the prefix is forthcoming.

11. One or more computer-readable media as recited in claim 8, wherein the computer executable instructions that, when executed by the one or more processors, further causes the one or more processors of a computer system to transmit a transience notification message identifying the route that is no longer valid to any neighboring routers for which the route was previously advertised.

12. A Border Gateway Protocol (BGP) router, comprising:
a routing table comprising routing information; and
a control unit, configured to receive a transience notification message identifying a route that is no longer valid, search the routing table for particular routing information that includes the route that is no longer valid; and mark the particular routing information as not valid.

13. The router as recited in claim 12, wherein the control unit is further configured to transmit a transience notification message identifying the transient route to any neighboring routers for which the route indicated by the transient notification message was previously advertised.

14. The router as recited in claim 12, wherein the control unit is configured to mark the particular routing information as not valid by deactivating any fields in the routing table comprising the route indicated by the transient notification message.

15. The router as recited in claim 12, wherein the control unit is further configured to process the transient notification message ahead of other standard routing messages.

16. A network, comprising: Border Gateway Protocol (BGP) speakers each configured to send and/or receive a transience notification message, invalidate a route indicated by the transient notification message; and prioritize receipt of the transience notification message over standard routing protocol messages.

17. The network as recited in claim 16, wherein the route is a pathway between two nodes that is no longer valid.

18. The network as recited in claim 16, wherein the BGP speakers propagate the transient notification message prior to generating update messages or withdraw messages.

19. A BGP speaker, comprising:
a router failure module, configured to detect when a neighboring speaker is unavailable; and
a transient notification module, configured to transmit a transient notification message to one or more other speakers indicating that a pathway to the neighboring speaker and/or the neighboring speaker itself is unavailable.

20. The BGP speaker as recited in claim 19, wherein the router failure module comprises an aging timer that is reset to zero each time the BGP speaker receives information from the neighboring BGP speaker, but if the aging timer reaches a predetermined value in which no information is received from the neighboring BGP speaker, the router failure module assumes that the neighboring BGP speaker is unavailable.

21. The router as recited in claim 19, wherein the router failure module assumes that the neighboring BGP speaker is unavailable if no active communication messages are received from the neighboring BGP speaker after a predetermined time period.
